(19) United States
(12) Patent Application Publication
(10) Pub. No.: US 2005/0256823 A1
(43) Pub. Date: Nov. 17, 2005

(54) Memory, method, and program product for organizing data using a compressed trie table

(76) Inventor: Robert Young Seward, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/844,654

(22) Filed: May 13, 2004

(51) Int. Cl. G06F 7/00

(52) U.S. Cl. 707/1

(57) ABSTRACT

A modified trie table for indexing data and permitting fast access according to a search key in a digital device is present in a memory system. The table may include compressed table elements having a flags field having a compressed value. Each compressed table element has a plurality of KeyString fields to be compared against portions of a search key, and a plurality of pointers, where each pointer is associated with a KeyString field. The table may also has uncompressed table elements, the uncompressed table elements having a flags field having an uncompressed value. Each uncompressed table element has pointers, wherein a portion of the search key is used to select a pointer of the plurality of pointers when the table is searched.

### FIELD OF THE INVENTION

The present document applies to the field of digital devices that organize, store, and retrieve data.

### BACKGROUND OF THE INVENTION

Digital devices, including computers, are frequently used to store and access data. This data may be organized in a database, or may be data used in other applications. Data used in other applications, for example, may comprise spellchecking dictionaries, one or more electronic books, or network routing and name translation information. Databases, including such databases as the Google index of the Internet, can contain enormous amounts of data.

It is often desirable to locate data in a dataset that has one or more attributes that match a specific search key. When access of data in a large database or other large dataset is needed, it is generally far more efficient to find entries in an index that match the search key than it is to examine all data in the dataset for matching records.

The larger the dataset and the greater the flexibility with which data in the dataset can be searched, the larger indices of the dataset tend to be. It is desirable to minimize the size of database indices. It is also desirable to structure database indices such that they can be accessed with a small number of operations for each search.

When a dataset 201 is accessed through a conventional Trie Table, as illustrated in FIG. 1, a root pointer 200 points to a table element 202 in memory. Typically, when the dataset 201 is searchable by text strings, table element 202 contains a list of pointers containing a number of pointers 204, 206, 208 greater than or equal to the number of characters in the character set permissible in the strings. For example, if the strings are allowed to contain only lower case English letters, there may be twenty-six pointers 204, 206, 208 in each table element 202. If the key strings are permitted to contain upper and lower case letters, thereby permitting “PhD” to be distinguished during search from “phD”, space may be allocated for fifty-two or more pointers in each table element 202. Each pointer, such as pointer 204, may contain a null value (not shown), or may point to a further table element 210. Pointers, such as pointer 212, may also point to a data record in the dataset 201.

When the dataset 201 is searched for data matching a key, the first character of the key is used as an index into the list of pointers in the first table element 202, thereby selecting the pointer 204. The pointer 204 is followed and the next character of the key is used as an index into the list of pointers in any further table element, such as table element 210, thereby selecting another pointer 212. Each list of pointers is therefore indexable by a key character. The process continues until all characters of the key have been used as indexes into lists of pointers and desired data 220 has been found; or a selected pointer is a null pointer, indicating that there is no data available that matches the key.

It is known that trie tables as heretofore described may consume excessive memory if many table elements 202, also known as table nodes, are nearly empty. Consider, for example, an English language dictionary searched by a word processor during spell checking with one level of the trie table for each successive character of a word. While levels close to the root of the trie table have meaningful entries in many of the pointer locations 204, 206, 208 of each table element 202, it is known that table elements at lower levels of the trie table may include mostly null pointers. Table elements that include mostly null pointers are sparsely populated table elements.

With a conventional trie table, sparsely populated table elements may consume considerable amounts of memory, especially if a very large dataset is thoroughly indexed. It is desirable to reduce the amount of memory occupied by null pointers in such a trie table as may be used to index large datasets.

### BRIEF DESCRIPTION OF THE FIGURES

FIG. 1 is a diagram of a prior art trie table

FIG. 2 illustrates an apparatus capable of storing, organizing, and/or accessing data

FIG. 3 is a diagram of a compressed trie table

FIG. 4 illustrates fields within a flag word associated with table elements of a compressed trie table.

FIG. 5 illustrates an alternative organization of a table element.

FIG. 6 is a flowchart of a method for organizing a trie table.

FIG. 7 illustrates fields within a data element of a database addressed through the compressed trie table.

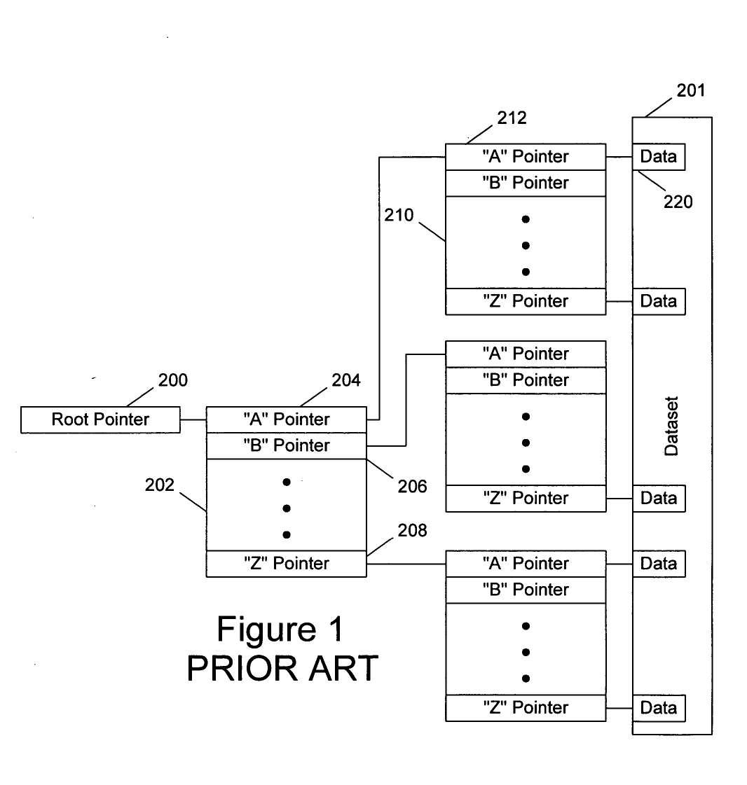

### DETAILED DESCRIPTION OF THE EMBODIMENTS

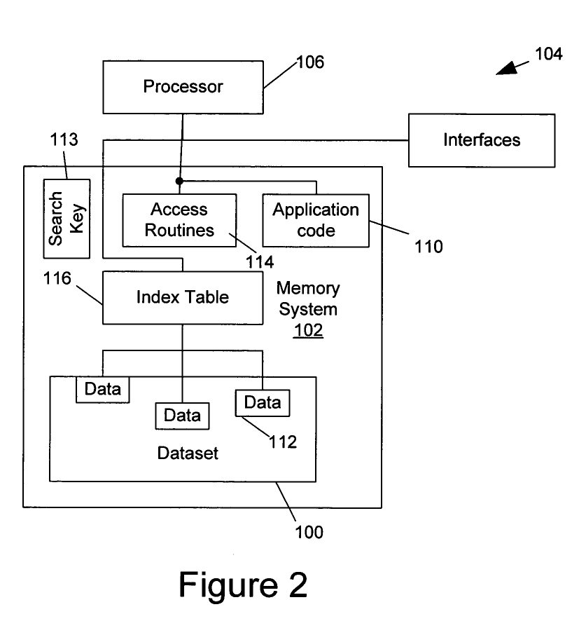

A digital device 104, illustrated in FIG. 2, incorporates a dataset 100 that is searched during the device's operation. The dataset 100, or database, is in a memory system 102 of the digital device 104. Memory system 102 may have multiple levels, and may contain both random-access memory (RAM) and disk memory subsystems.

A processor 106 of the device 104 executes application code or application firmware 110 in memory system 102. When application code 110 needs to find a data record 112 having one or more attributes that match a particular search key 113, application code 110 calls access routines 114 such that the access routines 114 are executed on a processor 106 of the device 104. The access routines 114 locate the data record 112 through information embedded in index table 116.

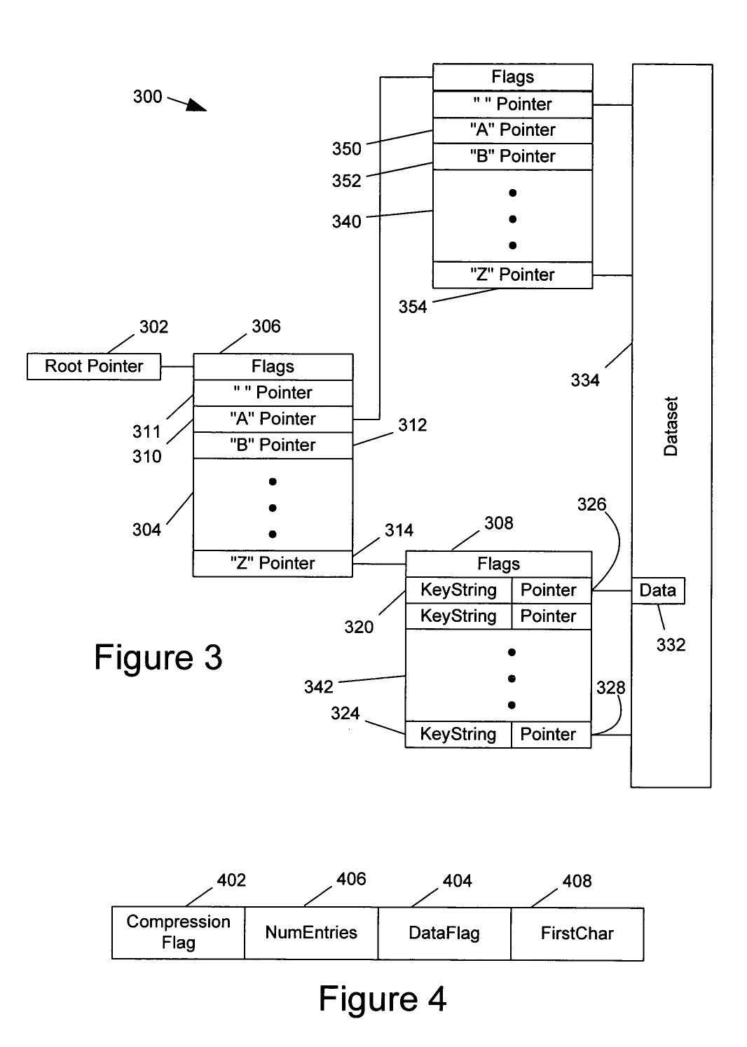

Index table 116 and dataset 100 of the digital device embodying the invention are implemented with a compressed trie table as illustrated in FIG. 3.

A database or other addressable dataset 300 (FIG. 3) indexed by a compressed trie table has a root pointer 302 that points to a root table element 304. Each table element 304, 340, 342, including root table element 304, has flags, such as flags 306, 308. Flags 306, 308 are located at the start of each table element 304, 340, 342.

As illustrated in FIG. 4, flags 306, 308 (FIG. 3) includes a compression flag 402. The compression flag 402 has a first value when the table element is uncompressed. When a table element is uncompressed, it contains a list of pointers 310, 312, 314 indexable by a key character. In an embodiment, the list of pointers includes a pointer 311 associated with a string terminator key character.

The compression flag 402 has a second value when the table element is compressed. As illustrated in FIG. 3, when the table element is compressed, it contains a sorted list of key string characters KeyString 320, 324 and a list of corresponding pointers 326, 328 associated therewith.

Flags 306, 308 also includes a data flag 404. Data flag 404 has a first value if the record of which it is a part is a table element 304, 340, 342, and a second value if the record is a data element 332 of the indexed dataset 334. Other embodiments may use other methods of distinguishing table elements 304, 340, 342 from data elements 332 of dataset 334. One such alternative method of distinguishing table elements from data elements may involve locating table elements 304, 340, 342 in a separate section of memory from dataset 334 and inspecting the associated pointer to determine which section of memory is referenced.

One KeyString 320, 322, 324 value of each table element may have a string terminator value.

Flags 308 of compressed table elements, such as table element 342, also includes a count of entries NumEntries 406 in the table element 342 that contain valid pairs of key string characters KeyString 320, 322, and corresponding pointers 326, 328.

When a table element, such as table element 342, contains few non-null pointers 326, 328, the table element is provided as a compressed table element to save memory space. When a table element, such as table element 340, contains many non-null pointers 350, 352, 354, the table element is stored as an uncompressed table element. During index creation and addition of new entries, compressed table elements are converted to uncompressed table elements when the table element expands to the point that the space savings of compressed form is small.

In an alternative embodiment, uncompressed table elements 304, 340 are stored in thrifted form. In this embodiment, Flags 306, 308 of uncompressed table elements includes a first character field FirstChar 408. The FirstChar and NumEntries field contents represent boundaries of a subset of the entire character set that is used in a particular table element. No pointers 350 are provided for possible key characters outside the range FirstChar to FirstChar+NumEntries; pointers 352 are provided only for possible key characters within the range.

A single trie table may have table elements in compressed and thrifted formats.

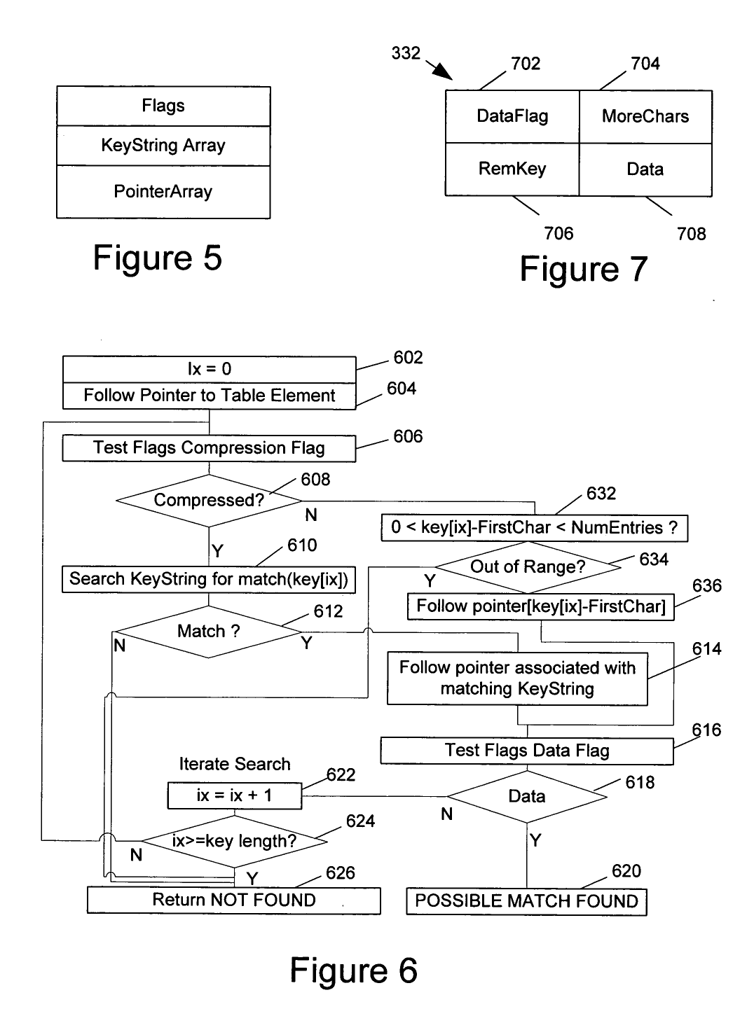

The pairing of KeyString 320 and Pointer 326 elements illustrated in FIG. 3 is for illustration of necessary fields in a table element; while these may be stored in pairs as illustrated they may also be stored as separate arrays as illustrated in FIG. 5.

When it is desired to search a dataset 334 for a data element 332 having an attribute that matches a search key, a search routine of access routines 114 is executed. A search routine for use with thrifted and compressed table entries is illustrated in FIG. 6. Search routines of greater complexity may be used; including search routines capable of handling “wild-card” characters and returning multiple matches.

The search routine begins by setting 602 an index IX to zero; index IX specifies which character of a key string is being processed at a particular point in the search. The root pointer is followed 604 to the first table element. The compression flag 402 of the flags 306 of the table element is tested 606 to determine whether this table element is in compressed or uncompressed form. If 608 the element is in compressed form, the KeyString fields 320, 322 are searched 610 for a KeyString field having contents matching a character of the key string selected according to the index IX. If 612 a match is found, the associated pointer is followed to another table element, or to a data element 332. If no match is found, a no match return 626 occurs.

Each data element, such as data element 332, has flags as illustrated in FIG. 7. Among these flags is a data flag 702, having a value indicative that the data element 332 is a data element.

The data flag 404 or 702 of flags of the table or data element found by following the pointer is checked 616 to determine whether a data element or a further table element has been found. If 618 a data element has been found, that data element is returned 620 to the application program 112 as a potentially matching data element. If 618 a further table element was found, the index IX is advanced 622 and compared 624 against the length of the search key. If 624 the index IX exceeds the length of the search key a return NOT FOUND 626 occurs.

If 624 the index IX is still within bounds, the next character of search key is tested against the other table element by looping back to testing 606 the compression flag 402 of the flags 306 of the other table element.

When a thrifted table element is found during testing 606 of the compression flag 402 of flags 306 of a table element, a test 632 is performed to determine if the currently selected key character key[ix] is within the range of FirsChar to FirstChar+NumEntries. If 634 the key character is outside the range, a return NOT FOUND 626 occurs. If 634 the key character is in range, the key character is used to select a pointer, such as pointer 352, from the pointers stored in the table entry. This pointer is followed, if not null, and a data flag is tested 616 to determine whether data has been found. Whenever a null pointer is found, a return NOT FOUND is performed 626.

In a particular embodiment, KeyString fields 320, 322 and their corresponding pointers 326, 328 are stored sorted by KeyString field contents. In this embodiment, searching 610 the KeyString field for a match against a character of the search key is performed with a binary search.

When a possible match is found 620, a MoreChars field 704 in flags (FIG. 7) of the located data element 332 is tested for zero. If it is nonzero, the data element 332 contains remaining key characters RemKey 706 that may be compared against any remaining characters of the search key to determine if an exact match of the search key has been found, implying that correct data 708 has been found.

While the KeyString 322 field of compressed table elements 342 generally contains a character of a string against which a character of the key string is searched 610 for matches, this field may contain multiple characters of key string or may contain other indexing information upon which a search is to be performed.

A computer program product is any machine-readable media, such as an EPROM, ROM, RAM, DRAM, disk memory, or tape, having recorded on it computer readable code that, when read by and executed on a computer, instructs that computer to perform a particular method, function or sequence of functions. The computer readable code of a program product may be part or all of a program, such as dataset search and database insert functions. A digital device containing a computer readable code for executing dataset search and insertion tasks as herein described is a computer program product.

While the forgoing has been particularly shown and described with reference to particular embodiments thereof, it will be understood by those skilled in the art that various other changes in the form and details may be made without departing from the spirit and hereof. It is to be understood that various changes may be made in adapting the description to different embodiments without departing from the broader concepts disclosed herein and comprehended by the claims that follow.

1. A memory system, having recorded therein an index table for indexing a database according to a search key, wherein the index table comprises compressed table elements further comprising:
a flags field, the flags field further comprising a compressed flag field having a compressed value,
a plurality of KeyString fields comparable against portions of the search key, and
a plurality of pointers, where each pointer is associated with a KeyString field; and
wherein the index table comprises uncompressed table elements, the uncompressed table elements further comprising:
a flags field, the flags field further comprising a compressed flag field having an uncompressed value, and
a list of uncompressed pointers comprising a plurality of pointers, wherein a portion of the search key is usable to select by indexing a pointer of the plurality of pointers of the list of uncompressed pointers.

2. The memory system of claim 1, wherein the flags field of the uncompressed table elements further comprises a FirstChar field and a NumEntries field together indicative of a size of the list of uncompressed pointers.

3. The memory system of claim 1, wherein the compressed table elements contain paired KeyString fields and pointers stored in order of KeyString field contents.

4. A method for accessing data in a digital device according to a key string comprising:
testing a compression flag of a table element to determine whether the table element is in a compressed or a uncompressed form;
if the table element is in compressed form, searching KeyString fields of the table element for a KeyString field matching a portion of the key string and selecting a corresponding pointer; and
if the table element is in uncompressed form, using a portion of the key string to select a pointer from a plurality of pointers stored in the table element.

5. The method of claim 4, wherein, for table elements in uncompressed form, the method further comprises the steps of determining if the portion of the key string is within a range specified in a flag stored in the table element.

6. A computer program product comprising a machine readable memory having recorded therein an index table for indexing a dataset according to a search key, wherein the index table comprises compressed table elements further comprising:
a flags field, the flags field further comprising a compressed flag field having a compressed value,
a plurality of KeyString fields comparable against portions of a search key, and
a plurality of pointers, where each pointer is associated with a KeyString field; and
uncompressed table elements, the uncompressed table elements further comprising:
a flags field, the flags field further comprising a compressed flag field having an uncompressed value, and
a plurality of uncompressed pointers, wherein a portion of the search key is usable to select by indexing a pointer of the plurality of uncompressed pointers; and
wherein the machine readable memory has recorded therein computer readable code for instructing a processor to execute steps comprising:
testing the compressed flag field of a selected table element of the index table to determine whether the selected table element is a compressed table element or a uncompressed table element;
if the table element is a compressed table element, searching the KeyString fields of the table element for a match against a portion of the search key and selecting a corresponding pointer of the table element; and
if the table element is an uncompressed table element, using a portion of the search key to select a pointer from the plurality of pointers of the table element.

7. The computer program product of claim 6 wherein the flags field of the index table recorded in the machine readable memory further comprises a data flag having a first value indicative of a table element, and where the machine readable memory contains a plurality of data elements, the data elements having a flags field comprising a data flag having a second value indicative of a data element.
